(19) United States
(12) Patent Application Publication
(10) Pub. No.: US 2008/0169711 A1
(43) Pub. Date: Jul. 17, 2008

(54) Wire Protection Apparatus for High Frequency Motor

(76) Inventor: Young-Jin Hyun, Ansan-Si Kyungki-Do (KR)

Correspondence Address: IPLA P.A., 3580 WILSHIRE BLVD., 17TH FLOOR, LOS ANGELES, CA, 90010, US

(21) Appl. No.: 10/595,324

(22) PCT Filed: Oct. 8, 2004
(86) PCT No.: PCT/KR2004/002580

§ 371 Date: Apr. 7, 2006

(30) Foreign Application Priority Data
Oct. 9, 2003 (KR) 10-2003-0070316

(51) Int. Cl. H02K 5/22; H02K 11/00

(52) U.S. Cl. 310/71; 310/90; 310/68 C; 310/89

(57) ABSTRACT

Disclosed is a wire protection apparatus for a high frequency motor capable of preventing wires of a stator of the high frequency motor or wires of sensors from being exposed out of a clad cable while effectively preventing a part of wires from being damaged or disconnected due to external impact applied to wires when the high frequency motor is disassembled for exchanging a bearing or repairing work.

### TECHNICAL FIELD

The present invention relates to a motor, and more particularly to a wire protection apparatus for a high frequency motor capable of preventing wires of a stator of the high frequency motor or wires of sensors from being exposed out of a clad cable while effectively preventing a part of wires from being damaged or disconnected due to external impact applied to wires when the high frequency motor is disassembled for exchanging a bearing or repairing work.

### BACKGROUND ART

Generally, a high frequency motor signifies a motor generating high rotational force when power having a high frequency is applied thereto. The high frequency motor generates higher rotational force and a higher output as compared with a general motor and represents a superior output ratio per a volume. Such a high frequency motor can generate rotational force in a range of about 5000 R.P.M to several hundreds of thousands R.P.M and can produce an output less than 1 Kw or more than 100 Kw.

Therefore, the high frequency motor and parts of the high frequency motor must be fabricated with high precision and must have a solid structure. Thus, the high frequency motor is quite expensive.

FIG. 5 shows a conventional high frequency motor. As shown in FIG. 5, the conventional high frequency motor includes a main casing 110. A stator 112 is installed in the main casing 110 in order to generate a magnetic field when power is applied thereto and a rotor 115 is aligned in a hollow section of the stator 112. A shaft 114 extends while passing through a central hole of the rotor 115 and both ends of the shaft 114 are supported by bearings 116.

In addition, working tools (not shown) are coupled to a collet 140 provided at a front end of the shaft 114 such that the working tools are rotated when the high frequency motor is driven.

An auxiliary casing 120 is coupled to one side of the main casing 110 and a connector 130 coupled with a power supply terminal 132 is provided at a rear end portion of the auxiliary casing 120. Electric wires L withdrawn from the connector 130 are connected to the stator 112 through a shielding plate 132 provided between the connector 130 and the shaft 114.

Accordingly, when the power supply terminal 132 is coupled with the connector 130, power is supplied to the connector 130, and then, is supplied to the stator 112 through the electric wires L. Thus, the stator 112 generates a magnetic field so that the shaft 114 aligned in the stator 112 may rotate.

In such a conventional high frequency motor, the bearings 116 rotating at a high speed must be periodically exchanged with new ones. When exchanging the bearings 116, the auxiliary casing 120 is primarily disassembled from the main casing 110 and a coupling member 122 is released from a bearing housing 118 in order to disassemble the bearing housing 118 from the main casing 110. After that, the bearings 116 are exchanged with new ones.

However, according to the conventional high frequency motor, when the auxiliary casing 120 has been disassembled from the main casing 110, the auxiliary casing 120 dangles from the main casing 110 due to the electric wires L connected between the stator 112 and the connector 130.

If a worker exchanges the bearings 116 with new ones under the above circumference, excessive load is applied to the electric wires L due to a tare of the auxiliary casing 120. In an extreme case, a part of the electric wires L may be disconnected or ends of the electric wires L may be separated from the stator 112 or the connector 130.

### DISCLOSURE OF THE INVENTION

Therefore, the present invention has been made in view of the above-mentioned problems, and it is an object of the present invention to provide a high frequency motor capable of preventing electric wires from being disconnected or damaged by protecting the electric wires from excessive force when performing bearing exchange work.

In order to accomplish the above object, there is provided a wire protection apparatus for a high frequency motor including a stator, a shaft installed in an inner hollow section of the stator so as to be rotated by means of the stator, and a plurality of bearings supporting both ends of the shaft in order to assist rotation of the shaft, the wire protection apparatus comprising: a main casing partially surrounding the stator, the shaft and bearings and being formed at one side thereof with a wire path for allowing electric wires of the stator to pass through the main casing; and a wire protection member having a tubular structure for allowing electric wires to pass through the wire protection member and being coupled to the wire path of the main casing, wherein electric wires extending from the stator are aligned in such a manner that the electric wires are withdrawn to an exterior without being interrupted by an auxiliary casing detachably coupled to one side of the main casing as to enable a worker to exchange the bearings with new ones.

According to the preferred embodiment of the present invention, the auxiliary casing is detachably coupled to one side of the main casing as to enable a worker to exchange the bearings with new ones and an arcuate guide groove is formed at an outer peripheral portion of the auxiliary bearing so as to allow the wire protection member to pass through the auxiliary casing.

A ground wire connection ring is installed in the wire path coupled with the wire protection member in order to align a ground wire together with the electric wires.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a sectional view illustrating a high frequency motor according to one embodiment of the present invention;

FIG. 2 is an enlarged view of an “A” portion shown in FIG. 1;

FIG. 3 is a perspective view illustrating an auxiliary casing shown in FIG. 1;

FIG. 4 is a perspective view illustrating a ground wire connection ring shown in FIG. 1; and

FIG. 5 is a sectional view illustrating a conventional high frequency motor.

### BEST MODE FOR CARRYING OUT THE INVENTION

Reference will now be made in detail to the preferred embodiments of the present invention.

Hereinafter, a preferred embodiment of the present invention will be described with reference to accompanying drawings.

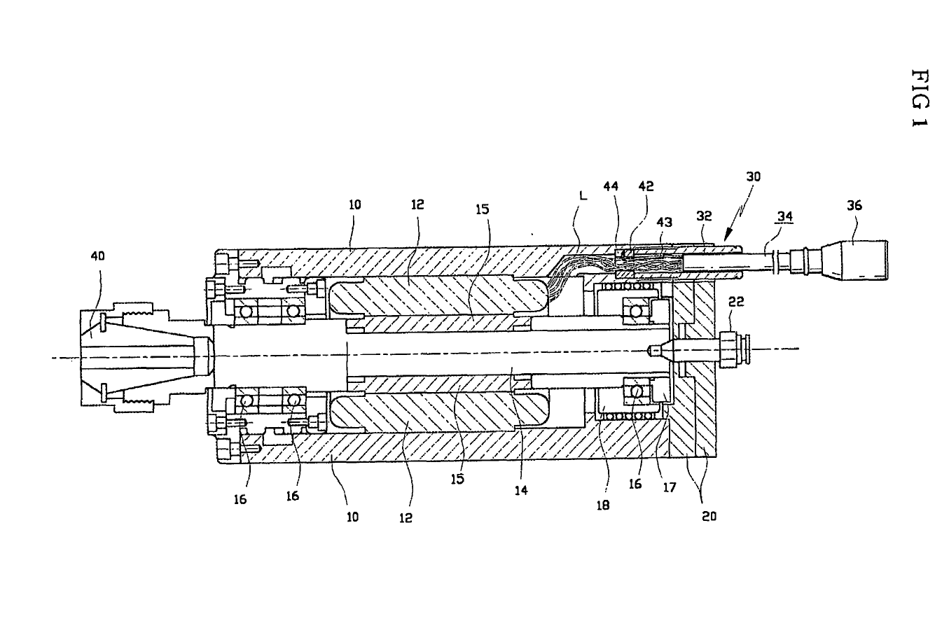

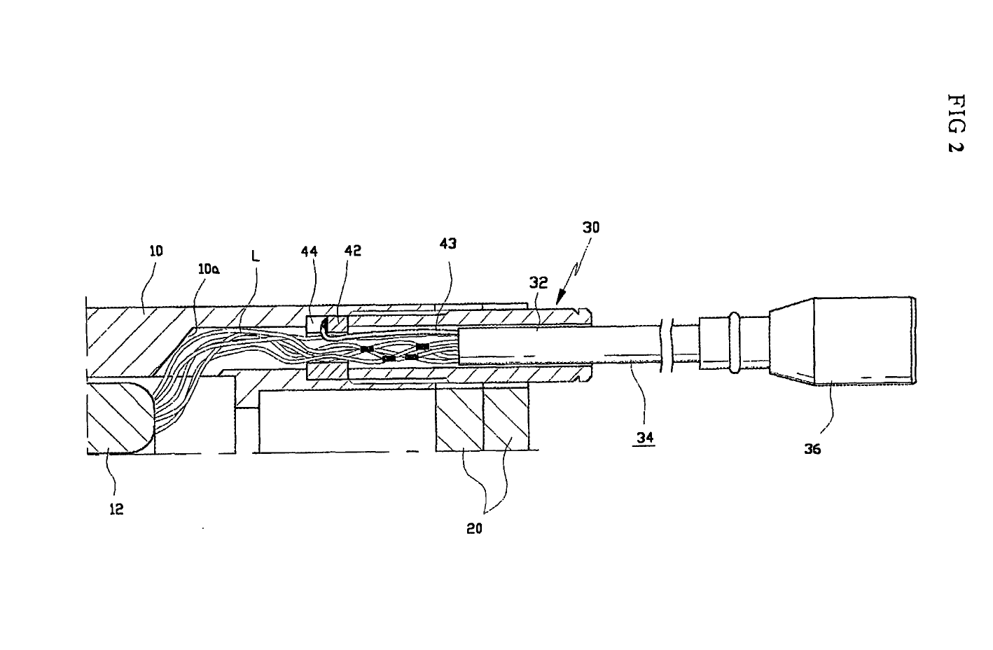

FIG. 1 is a sectional view illustrating a high frequency motor according to one embodiment of the present invention, and FIG. 2 is an enlarged view of an “A” portion shown in FIG. 1.

The high frequency motor of the present invention includes a main casing 10. A stator 12 is installed in the main casing 10 in order to generate a magnetic field when power is applied thereto and a rotor 15 is aligned in a hollow section of the stator 12. A shaft 14 extends while passing through a central hole of the rotor 15. A collet 40 is provided at a front end of the shaft 14 so as to selectively grip working tools to be rotated.

A plurality of bearings 16 are provided at both ends of the shaft 14 extending by passing through the center of the stator 12 so as to assist rotation of the shaft 12 caused by the stator 12.

A bearing housing 18 and a lock nut 17 are provided in order to fixedly support the bearings 16. Besides the stator 12, the shaft 14, bearings 16, the lock nut 17, and the bearing housing 18, the main casing 10 is provided therein with a bolt and a ring member in order to fix or seal the above parts. However, since the wire protection structure of the present invention does not directly relate to the bolt and the ring member, they will not be further described below.

A wire path 10a is formed at an end of the main casing 10 so as to allow electric wires L of the stator 12 to pass therethrough. The wire path 10a extends from the end of the main casing 10 to a position of the stator 12 along the shaft 14.

An auxiliary casing 20 coupled to one side of the main casing 10 is shown in FIG. 1. According to the present invention, the auxiliary casing 20 includes two plate members having a predetermined thickness and is coupled to one end of the main casing 10. In most cases, the auxiliary casing 20 covers one end of the main casing 10 and is formed with a cooling water passage or a pressurized air passage in order to feed cooling fluid into the main housing 10 for cooling the high frequency motor or to prevent impurities from penetrating into the high frequency motor by forming a negative pressure state in the high frequency motor.

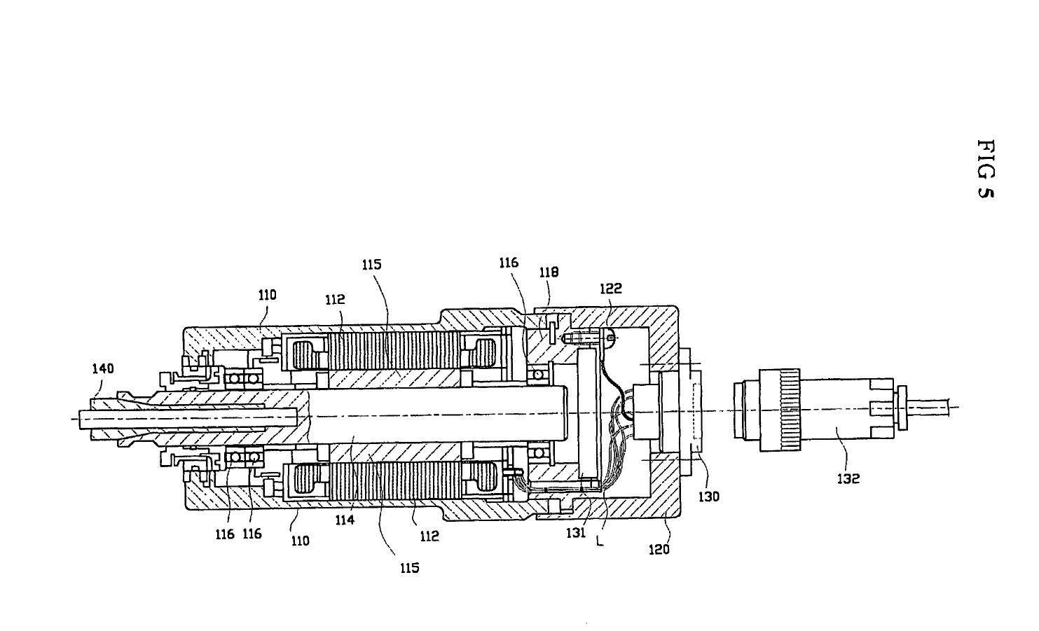

As shown in FIG. 4, the auxiliary casing 20 is formed at an outer peripheral portion thereof with an arcuate guide groove 20c for allowing a wire protection member 30 to pass through the auxiliary casing 20.

The arcuate guide groove 20c formed at the outer peripheral portion of the auxiliary casing 20 is necessary to prevent interference between the auxiliary casing 20 and the wire protection member 30, which is integrally coupled with the main casing 10 and extends into the wire path 10a, when the auxiliary casing 20 is assembled/disassembled into/from the main casing 10 for exchanging the bearings 16 with new ones.

Meanwhile, in the conventional high frequency motor shown in FIG. 5, electric wires L extending from the stator 112 are connected to the connector 130. However, according to the present invention, as shown in FIGS. 1 and 2, the electric wires L extending from the stator 12 are withdrawn out of the high frequency motor through the wire path 10a of the main casing 10 and the wire protection member 30. Therefore, the wire protection member 30 is preferably made from a tubular member so as to allow the electric wires L to pass through the wire protection member 30. In addition, as shown in FIG. 2, one end 30a of the wire protection member 30 is coupled into the wire path 10a of the main casing 10.

That is, a male thread section is formed at an outer peripheral portion of a front end of the wire protection member 30 and a female thread section is formed at an inner surface of an outlet portion of the wire path 10a so as to allow the wire protection member 30 to be screw-coupled into the wire path 10a. Accordingly, the electric wires L extending to an exterior through the wire path 10a are stably protected by means of the wire protection member 30.

In addition, a ground wire connection ring 42 is installed in the wire path 10a coupled with the wire protection member 30 in such a manner that a ground wire 43 can be aligned with the electric wires L.

To this end, a stopper protrusion 10b is formed at an inner end portion of the wire path 10a. The stopper protrusion 10b prevents the ground wire connection ring 42 from moving beyond the inner end portion of the wire path 10a by making contact with the ground wire connection ring 42.

That is, one side of the ground wire connection ring 42 is supported by means of the stopper protrusion 10b and the other side of the ground wire connection ring 42 is secured by means of a front end of the wire protection member 30, which is screw-coupled with the wire path 10a.

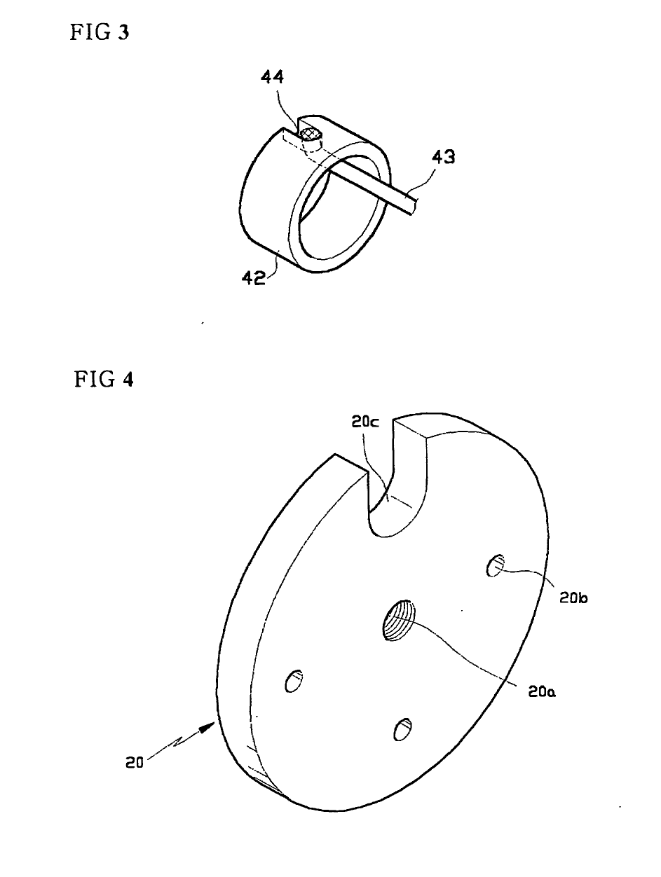

As shown in FIG. 3, the ground wire connection ring 42 is formed at one side thereof with a support groove 44 in order to fix the ground wire 43 inserted into the ground wire connection ring 42 to the ground wire connection ring 42 through a predetermined welding method such as soldering.

The electric wires L are wires extending from the stator 12 or various sensors including a temperature sensor or a position sensor installed in the main casing 10. The electric wires L are withdrawn to the exterior through the wire path 10a of the main casing 10 and the wire protection member 30 in the form of a clad cable 34 including a clad 32.

An additional connector 36 can be coupled to an end of the clad cable 34 so as to supply power to the high frequency motor.

### INDUSTRIAL APPLICABILITY

As can be seen from the foregoing, according to the present invention, the electric wires L in the form of the clad cable 34 are withdrawn to the exterior through the wire path 10a and the wire protection member 30 when the auxiliary casing 20 is disassembled from the main casing 10 in order to exchange the bearings of the high frequency motor, so the electric wires L are not directly exposed to the exterior. Thus, the electric wires L can be prevented from being disconnected or damaged.

In addition, according to the present invention, assembling work and reliability for the high frequency motor can be improved.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A wire protection apparatus for a high frequency motor including a stator, a shaft installed in an inner hollow section of the stator so as to be rotated by means of the stator, and a plurality of bearings supporting both ends of the shaft in order to assist rotation of the shaft, the wire protection apparatus comprising:
a main casing partially surrounding the stator, the shaft and bearings and being formed at one side thereof with a wire path for allowing electric wires of the stator to pass through the main casing; and
a wire protection member having a tubular structure for allowing electric wires to pass through the wire protection member and being coupled to the wire path of the main casing, wherein electric wires extending from the stator are aligned in such a manner that the electric wires are withdrawn to an exterior without being interrupted by an auxiliary casing detachably coupled to one side of the main casing as to enable a worker to exchange the bearings with new ones.

2. The wire protection apparatus as claimed in claim 1, wherein the electric wires extending from the stator are surrounded by a clad, thereby forming a clad cable, and the clad cable extends from the wire path of the main casing or a part of the wire protection member to an exterior.

3. The wire protection apparatus as claimed in claim 1, wherein the auxiliary casing is detachably coupled to one side of the main casing as to enable a worker to exchange the bearings with new ones and an arcuate guide groove is formed at an outer peripheral portion of the auxiliary bearing so as to allow the wire protection member to pass through the auxiliary casing.

4. The wire protection apparatus as claimed in claim 1, wherein the electric wires extend from the stator or from at least one of a temperature sensor and a position sensor.

5. The wire protection apparatus as claimed in claim 1, wherein a power supply connector is coupled to exposed ends of the electric wires surrounded by the clad cable.

6. The wire protection apparatus as claimed in claim 1, wherein the wire protection member is screw-coupled with the wire path of the main casing.

7. The wire protection apparatus as claimed in claim 1, a ground wire connection ring is installed in the wire path coupled with the wire protection member.
